(19) United States
(12) Patent Application Publication
(10) Pub. No.: US 2007/0134629 A1
(43) Pub. Date: Jun. 14, 2007

(54) General-purpose language-learning system

(76) Inventor: Shian Yi Lin, Chiayi City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/636,558

(22) Filed: Dec. 11, 2006

(30) Foreign Application Priority Data
Dec. 13, 2005 (TW) 94143955

(51) Int. Cl. G09B 5/00

(52) U.S. Cl. 434/169; 434/317

(57) ABSTRACT

A general-purpose language-learning system includes at least one word carrier and an audio device. The word carrier includes at least one picture or at least one word corresponding to a primary meaning and a code number of Arabian figures corresponding to a secondary meaning that is substantially the same as the primary meaning. The audio device includes an input device. The input device includes an operational unit, an audio database, and an audio database carrier. The input device is connected to an audio output unit and includes a plurality of keys corresponding to the secondary meaning. Input. of the code number of Arabian figures obtains pronunciation of the primary meaning.

### BACKGROUND OF THE INVENTION

1. Field of the Invention

The present invention relates to a general-purpose language-learning system and, more particularly, to a general-purpose language-learning system suitable for various languages through easy input.

2. Description of the Related Art

Learning language is often limited to circumstances. Relatively, circumstances provide environments for learning. Customary pronunciation can be learned without identifying words. For example, children under school age speak before learning words, and aborigines verbally pass their culture from generation to generation.

Since objective circumstances are difficult to create at any time, many devices or auxiliary tools for assisting in learning language have been developed. Electronic dictionaries or electronic translators are popular nowadays. However, input of letters or pronunciation or character elements of a word is required, and a pronunciation key must be pressed to learn the pronunciation of the word when using the electronic dictionaries. Namely, the interface of the electronic dictionaries of this type pronounces through correspondence with word. Forms, pronunciation, and meanings must be considered in this system.

Input of character elements of the electronic dictionaries of this type is very limiting. For example, when it is desired to look up the form, pronunciation, and meaning of “dog” in English, it is desired to press the corresponding word character keys on the keyboard to input the Mandarin pronunciation or Mandarin word and then press “ENTER”. “DOG” will appear on the display, and a pronunciation key is then pressed for pronouncing. This is translation from Mandarin into English. Translation from English into operates in similar steps. Hence, a user must not only learn corresponding phonic symbols and character elements of “DOG” in Mandarin before learning the pronunciation of “DOG” in English, but also be familiar with the positions of the corresponding keys and corresponding input method. Although this learning system includes ordinary operational steps for learning, it is too slow for one who wishes to acquire the audio information only. There are other limitations of the electronic dictionaries. For example, pronunciation of a word without Mandarin phonic symbols or Mandarin character elements cannot be obtained, for input of this word is impossible. Similar situations exist in Japanese and French.

Furthermore, it is impossible for a child without the knowledge of letters to learn the pronunciation of a word through an electronic dictionary using this input system. Same or similar problems exist in language-learning cards and network translating systems.

### SUMMARY OF THE INVENTION

The primary objective of the present invention is to provide a general-purpose language-learning system comprising at least one word carrier and an audio device. The word carrier may be picture books, books, stickers, banners, signboards, newspapers, or magazines to increase application and popularity. The word carrier includes at least one picture or at least one word corresponding to a primary meaning and a code number of Arabian figures corresponding to a secondary meaning that is substantially the same as the primary meaning. The audio device includes an input device. The input device includes an operational unit, an audio database, and an audio database carrier. The input device is connected to an audio output unit and includes a plurality of keys in association with the secondary meaning. Input of the code number of Arabian figures obtains pronunciation of the primary meaning.

Hence, a user may learn the pronunciation of the word in a natural circumstance without the need of knowing spelling and the input method of the word. Troublesome operations are not necessary while allowing rapid acquirement of pronunciation, adding interest to learning and providing a convenient circumstance for children under school age or learners that only want to know the pronunciation.

The secondary objective of the present invention is to provide the above-mentioned general-purpose language-learning system, wherein, for supplement and auxiliary purposes, the code number is prefixed or suffixed with a mark selected from a group consisting of English characters, Roman characters, Latin characters, mathematical symbols, or punctuation marks that are less commonly used than Arabian figures.

The word carrier may further include English letters in association with the primary meaning corresponding to the picture or the word. This allows learning of English in addition to pronunciation.

The audio device may further include a device allowing network linking and downloading for updating the system or the database through network downloading. Hence, when the present invention is widely used, the code numbers can be commonly used through commercial and cultural advocacy.

The audio device may be a computer, mobile phone, personal digital assistant, or portable electronic device to allow wider application.

The audio database carrier may include hard disks, memory cards, servers, and optical disks, allowing storage/access and application in various forms.

Other objectives, advantages, and features of the invention will become more apparent from the following detailed description when taken in conjunction with the accompanying drawings.

### BRIEF DESCRIPTION OF THE DRAWINGS

FIG. 1 is a plan view of an example of a general-purpose language-learning system in accordance with the present invention.

FIG. 2 is a plan view of another example of the general-purpose language-learning system in accordance with the present invention.

FIG. 3 is a plan view of a further example of the general-purpose language-learning system in accordance with the present invention.

### DETAILED DESCRIPTION OF THE PREFERRED EMBODIMENTS

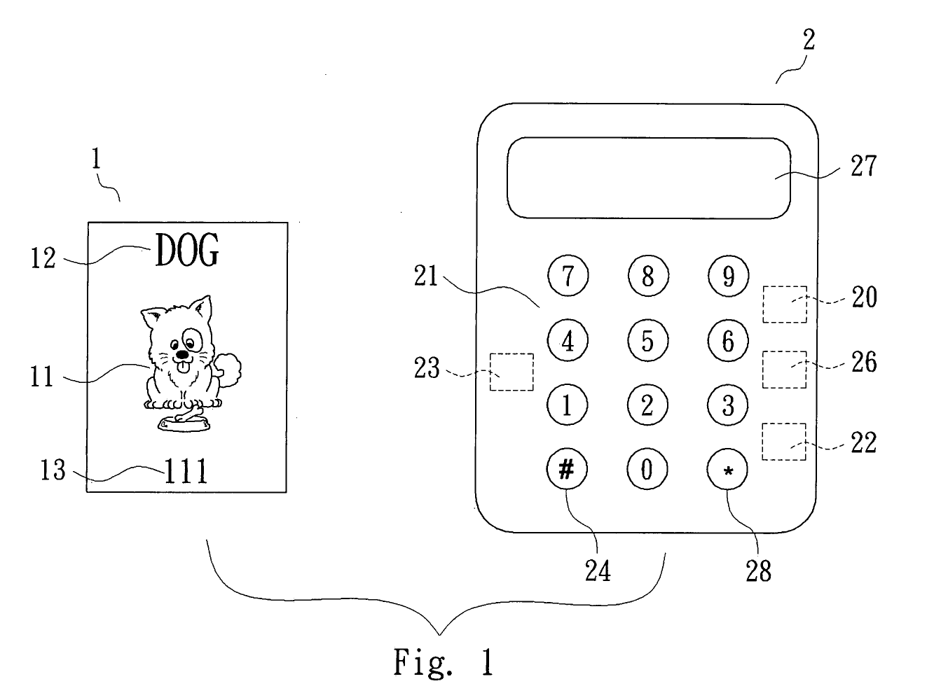

Referring to FIG. 1, an example of a general-purpose language-learning system in accordance with the present invention comprises at least one word carrier 1 such as a plurality of stickers, a picture book, or a book. The stickers may be adhered to walls of a house or daily necessities, or in a kindergarten. The word carrier 1 in the form of a book allows easy learning and identification by children. The word carrier 1 may be used with various media for propagation, such as banners, signboards, newspapers, and magazines.

The word carrier 1 includes a picture 11 or a word 12 corresponding to a primary meaning. For example, the picture 11 may show a dog accompanied by a corresponding word in a foreign language (such as “DOG” in English or a corresponding word in French, Japanese, etc.).

A corresponding code number 13 (“111” in this example) in Arabian figures is used for a secondary meaning that is the substantially same as the primary meaning. Namely, code number “111” means “DOG”. It is noted that Arabian figures are selected as the symbols for secondary meaning, as they are commonly used in various languages in the world. Hence, Arabian figures are used as common marks for pronunciation in the present invention.

The general-purpose language-learning system further comprises an audio device 2 including at least one input device 21 having a built-in operational unit 20, an audio database, and an audio database carrier 22. The audio database carrier 22 may include various media for storage, such as hard disks, memory cards, servers, optical disks, etc. The input device 21 is connected to an audio output unit 23. The input device 21 includes a plurality of keys 24 in association the secondary meaning. Namely, input of the code number 13 (the secondary meaning) obtains pronunciation of the primary meaning. The audio device 2 may be a computer, mobile phone, personal digital assistant (PDA), or portable electronic device. The audio device 2 may be connected to a display unit 27 for visual effect.

In use, a user or leaner inputs the code number 13 (“111”) on the word carrier 1 by pressing corresponding keys 24 of the input device 21, and corresponding pronunciation of “DOG” is searched throughout the database. Thus, the user knows the pronunciation of “DOG” through simple operations. The audio device 2 may include a language selection key 28 allowing the user to select different languages. For example, if Spanish is selected, the audio output unit 23 outputs pronunciation of “DOG” in Spanish. The user may learn the pronunciation of “DOG” without the knowledge of the phonic symbols of “DOG”, the input method of the phonic symbols (or other input methods), and the form of “DOG”. Troublesome operations are not required while providing an interesting environment for learning for children under school age.

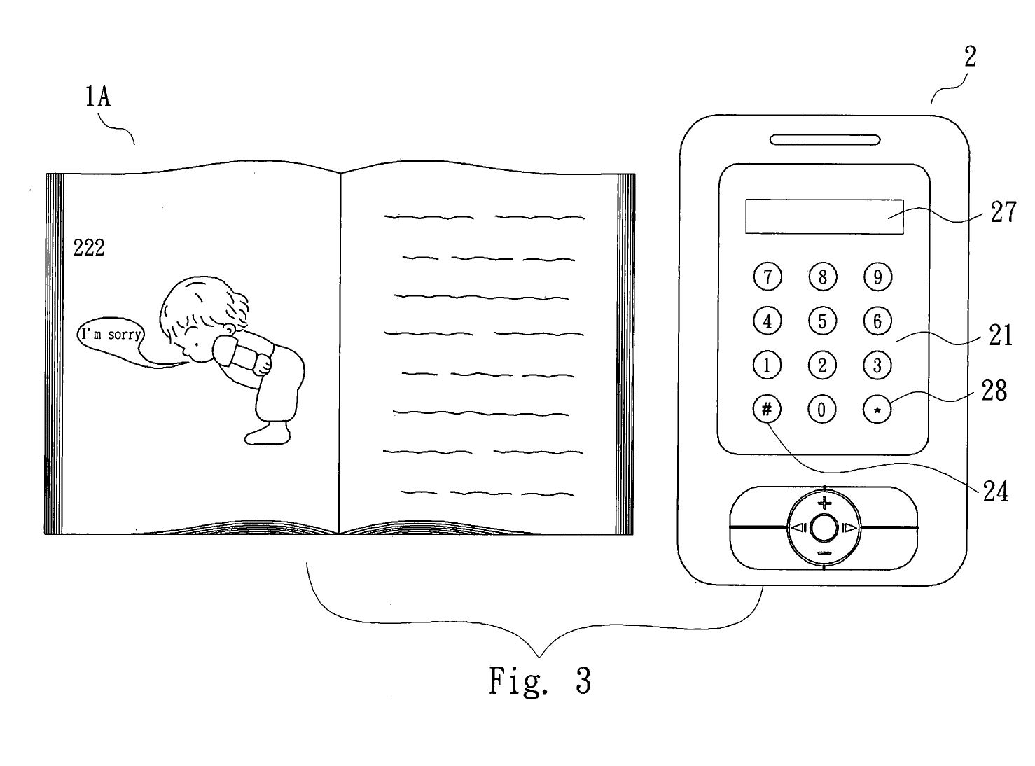

With reference to FIG. 3, basic conversations and regards can be presented by pictures. For example, input “222” will obtain pronunciation of “Excuse me” in a foreign language, which may obtain forgiveness immediately in an embarrassing situation. A useful, immediate aid in daily life regarding basic conversations and regards can be obtained while learning language. The code number “222” for “Excuse me” can be found in a word carrier 1A such as a portable pamphlet in which a bowing man clearly depicts the situation without the need of comprehending and inputting complicated words and the knowledge of input methods.

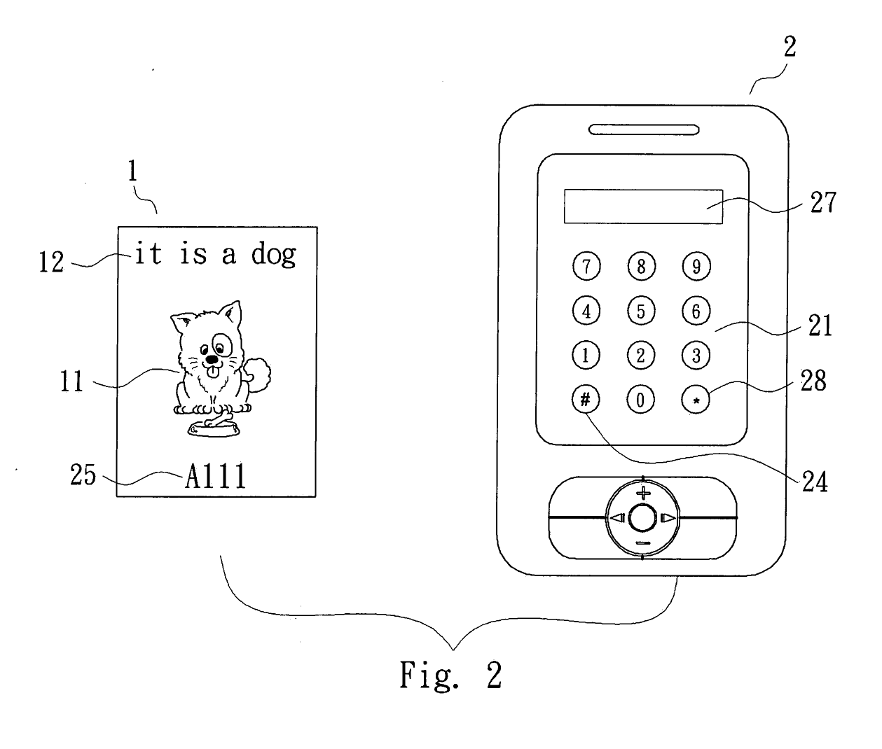

With reference to FIG. 2, in a case that the number of Arabian figures is not enough or for the purposes of providing distinction between different language systems, the code number may be prefixed or suffixed with a mark selected from a group consisting of English characters, Roman characters, Latin characters, mathematical symbols, or punctuation marks that are less commonly used than Arabian figures (see reference number 25). This may be used for ordering meals. In a preferred embodiment of the present invention, the word carrier 1 may further include an English word as a third meaning (such as a picture plus an English word), for English, though not accepted by all language systems, is a pretty common language. Preferably, the digit number of the Arabian figure “111” (reference number 13) is not greater than the number of the letters contained in the word in English for simplification purposes allowing rapid obtaining of the pronunciation.

It is noted that the present invention is not an ordinary electronic dictionary or language-learning tool. More specifically, the audio device 2 is a part of the present invention, not the sole subject matter of the present invention. Furthermore, number entry keys are used as input keys for pronunciation, allowing easy operation, for the positions of the number entry keys are familiar to most users and for there are only ten number entry keys (0-9) which is much less than the number of Mandarin phonic symbols and the number of English letters.

The audio device 2 of the present invention may include a device 26 allowing network linking and downloading. Hence, the system or the database can be updated through network downloading.

The audio database and the audio database carrier 22 may store pronunciation of different language systems and output pronunciation in a specific language upon selection through a selection key.

Although specific embodiments have been illustrated and described, numerous modifications and variations are still possible. The scope of the invention is limited by the accompanying claims.

What is claimed is:

1. A general-purpose language-learning system comprising:
at least one word carrier including at lease one picture or at least one word corresponding to a primary meaning and a code number of Arabian figures corresponding to a secondary meaning that is substantially the same as the primary meaning; and
an audio device including an input device, the input device including an operational unit, an audio database, and an audio database carrier, the input device being connected to an audio output unit, the input device including a plurality of keys in association with the secondary meaning;
wherein input of the code number of Arabian figures obtains pronunciation of the primary meaning.

2. The general-purpose language-learning system as claimed in claim 1 wherein the code number is prefixed or suffixed with a mark selected from a group consisting of English characters, Roman characters, Latin characters, mathematical symbols, or punctuation marks.

3. The general-purpose language-learning system as claimed in claim 1 wherein the word carrier further includes English letters in association with the primary meaning corresponding to the picture or the word.

4. The general-purpose language-learning system as claimed in claim 3 wherein a digit number of the Arabian figure is not greater than the number of the letters contained in the word in English.

5. The general-purpose language-learning system as claimed in claim 1 wherein the audio device includes a device allowing network linking and downloading for updating the system or the audio database through network downloading.

6. The general-purpose language-learning system as claimed in claim 1 wherein the audio device is a computer, mobile phone, personal digital assistant, or portable electronic device.

7. The general-purpose language-learning system as claimed in claim 1 wherein the audio database carrier is selected from a group consisting of hard disks, memory cards, servers, and optical disks.

8. The general-purpose language-learning system as claimed in claim 1 wherein the word carrier is selected from a group consisting of picture books, books, stickers, banners, signboards, newspapers, and magazines.
